(19) United States
(12) Patent Application Publication
(10) Pub. No.: US 2026/0324669 A1
(43) Pub. Date: Oct. 22, 2026

(54) METHOD OF PRODUCING A COFFEE PRODUCT

(71) Applicant: Koninklijke Douwe Egberts B.V., Utrecht (NL)

(72) Inventor: Anja Rahn, Utrecht (NL)

(21) Appl. No.: 19/686,384

(22) Filed: May 22, 2026

Related U.S. Application Data
(63) Continuation of application No. 18/265,211, filed on Dec. 7, 2021.

(30) Foreign Application Priority Data
Dec. 8, 2020 (GB) 2019324.9

(51) Int. Cl. A23F 5/18; A23F 5/24; A23F 5/26; A23F 5/28; A23F 5/36

(52) U.S. Cl. CPC A23F 5/18; A23F 5/243; A23F 5/26; A23F 5/28; A23F 5/36

(57) ABSTRACT

The present invention provides a method of obtaining an instant coffee product, the method comprising:
performing a first aqueous extraction by contacting roast and ground coffee beans with a soft water at a temperature of up to 140 °C to obtain a first coffee extract and partially spent coffee beans; and
performing a second aqueous extraction by contacting the partially spent coffee beans with a hard water at a temperature of from 175 to 205 °C to obtain a second coffee extract and spent coffee beans;
combining the first and second coffee extracts to form a combined extract; and
concentrating and optionally drying the combined extract to form the coffee product.

The present invention relates to a method of producing a coffee product, such as a coffee concentrate or a soluble coffee powder, having a reduced level of acrylamide.

The extraction of roast and ground coffee with water to obtain a high coffee-solids liquid coffee concentrate is well known. Moreover, it is well known to dry such a concentrate with spray- or freeze-drying to obtain a soluble beverage product. The liquid coffee concentrate and the soluble beverage product can then be reconstituted at the consumer's convenience with hot (or cold) water to obtain a coffee beverage. The industrial production of liquid coffee concentrates is associated with higher temperatures and pressures than coffee shop brewing systems. This allows a higher yield to be obtained from the beans and a lower waste stream, but has a side-effect that the coffee can adopt undesirable processing flavour notes.

More recently it has been discovered that food products that are subjected to high temperatures during processing often contain high levels of acrylamide. These temperatures can be reached during the first minutes of the coffee roasting process where the highest amount of acrylamide have been reported. Since acrylamide is a probably carcinogenic substance, the food industry is unified in trying to reduce the levels of acrylamide in food. It is therefore desirable to implement measures to reduce the levels of acrylamide that accumulate during the coffee production.

The level of acrylamide in instant coffee is of some concern to the industry. Commission Regulation (EU) 2017/2158 states that food manufacturers should be striving to achieve levels as low as reasonably achievable and benchmark levels for instant coffee have been set at 850 ppb. In roast and ground coffee, the challenge is particularly with the lighter roasts, since acrylamide degrades under the more severe roasting conditions.

Unlike most other food products, coffee shows a decrease in acrylamide with increasing processing (roasting) time. All foods show this effect if heated sufficiently but most have reserves of asparagine at the end of normal processing which replenishes lost acrylamide. However, with coffee all the asparagine is exhausted before processing is completed. The most probable mechanisms for loss of acrylamide are polymerisation, volatilisation, or reaction with other food components.

However, it has been observed that acrylamide increases during the extraction process used to produce instant coffee from roast and ground coffee, despite the fact that the key precursor, asparagine, has been exhausted. As a result, levels can be undesirably high.

It is known in the prior art that acrylamide falls very gradually during storage in roast and ground coffee; Guenther et al., Food Additives & Contaminants, Vol 24(sup1), p60 (2007). However, long term storage of coffee is associated with staling and flavour loss, so the product no longer meets the consumer expectations.

U.S. Pat. No. 7,220,440 describes such a method of reducing the level of asparagine in unroasted coffee beans comprising adding an asparagine-reducing enzyme, for example asparaginase, to the unroasted coffee beans. This reduces the level of asparagine with a subsequent reduction in acrylamide formation upon roasting. The method utilises an enzymatic treatment of the unroasted coffee beans. However, the method typically results in ‘off-flavours’, which can have a negative impact on the overall aroma and flavour profile of the final coffee product. Furthermore, un-immobilised enzymes may be inadvertently and impermissibly retained in the final coffee product.

More recently, it has been shown that acrylamide can be removed directly from coffee extracts obtained from the roasted beans. EP3254568 describes the use of an adsorbent resin for reducing acrylamide in a liquid coffee extract or soluble coffee. In this method, a liquid coffee extract is flowed over a bed of cationic adsorbent resin to achieve a reduction in acrylamide content. This method avoids some of the issues associated with enzyme activity on the unroasted beans. However, the production of coffee having a specific aroma and flavour profile is a precise and complex process, and any additional treatment step can adversely affect the properties of the final coffee product. Therefore, treatment of the liquid extract with an adsorbent resin can alter the aroma components present in the extract, and consequently may negatively affect the taste of the final coffee product.

JP2018033366 discloses a method of two-stage extraction of coffee. CN102422959 discloses a method of preparing instant coffee with two stages at different temperatures. JPH11276351 discloses a coffee maker where the hardness of the water can be adjusted to change the flavour of the coffee.

Accordingly, it is desirable to provide an improved coffee product and a method for preparing a coffee product having reduced acrylamide levels therein compared to an equivalent prior art method and/or to tackle at least some of the problems associated with the prior art or, at least, to provide a commercially viable alternative thereto. In particular, the aim of this invention is to reduce or eliminate the in situ formation of acrylamide during coffee processing.

In a first aspect, the present invention provides a method of obtaining an instant coffee product, the method comprising:
performing a first aqueous extraction by contacting roast and ground coffee beans with a soft water at a temperature of up to 140 °C to obtain a first coffee extract and partially spent coffee beans; and
performing a second aqueous extraction by contacting the partially spent coffee beans with a hard water at a temperature of from 175 to 205 °C to obtain a second coffee extract and spent coffee beans;
combining the first and second coffee extracts to form a combined extract; and concentrating and optionally drying the combined extract to form the coffee product.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Industrial coffee extraction conventionally comprises a series of sequential aqueous extraction steps. These steps increase in temperature as higher yields are obtained from the coffee beans. By performing the treatments stepwise, the first lower temperature step obtains the most soluble components of the coffee without subjecting them to temperatures at which they would degrade or be lost. The second and subsequent treatment steps are then conducted under hotter conditions where more soluble coffee material can be obtained.

It is conventional to conduct industrial extractions of coffee beans with soft water since, in view of the large volumes of water required, scale build up in the system is a considerable problem. Such systems may use industrial water softening systems to regulate their water quality and avoid this problem. Thus, it would not normally be the case that industrial coffee extraction would be performed with hard water. In any event, even if local water were to be used untreated, it would not be the case that different water hardnesses would be used in sequential extraction steps.

Divalent cations are well documented to mitigate acrylamide formation when occurring through a Maillard mechanism. While this is known that acrylamide formation can be mitigated in products such as French fries and baked goods by contacting them with divalent cation solutions before baking, this method does not directly translate to coffee extraction processes. In particular, it is known that acrylamide is initially formed during roasting and green beans would be too dense to economically infuse with a divalent cation solution before this roasting.

However, the inventors have found that additional acrylamide is formed during instant coffee manufacturing presenting a second opportunity to mitigate acrylamide formation. The inventors have particularly found that increasing levels of acrylamide are produced at higher temperature of extraction. This second opportunity is more suitable for this strategy as the cation can be efficiently distributed throughout the coffee slurry in a uniform manner before thermal processing. Furthermore, hard water is sufficiently rich in cations to mitigate acrylamide formation, avoiding the intentional addition of minerals to the water. Incorporating minerals in the water during the creation of the coffee slurry, before thermal processing, is an efficient mitigation strategy to reduce acrylamide in the final product.

By increasing the divalent cation content of the water added to the grounds before an extraction step, it is possible to mitigate in situ acrylamide formation. Without wishing to be bound by theory, these cations form a chelation complex with the precursors which are then unavailable to participate in the reaction that forms acrylamide. Accordingly, the method is able to reduce acrylamide levels in the final coffee product, e.g. the dried coffee powder, by at least 30% and preferably at least 40%.

A further advantage of this method is that the use of different water hardnesses complies with strict rules on adulteration of coffee during processing to make coffee products.

The method of the present invention provides an instant coffee product. By instant coffee product it is meant one which forms a coffee beverage on the addition of hot water. This includes both liquid coffee concentrates as well as soluble coffee powders, such as spray-dried and freeze-dried coffee powders.

The method comprises performing a first aqueous extraction by contacting roast and ground coffee beans with a soft water at a temperature of up to 140 °C to obtain a first coffee extract and partially spent coffee beans. The treatment temperature is preferably from 90 to 140 °C, preferably 120 to 140 °C.

Before performing the first aqueous extraction step the coffee beans may be subjected to a steam stripping or aroma recovery step. Such steps are well known in the art and yield an aroma fraction.

The method comprises performing a second aqueous extraction by contacting the partially spent coffee beans with a hard water at a temperature of from 175 to 205 °C to obtain a second coffee extract and spent coffee beans. The treatment temperature is preferably from 180 to 200 °C.

The method may further comprise a further extraction step after the first extraction and before the second extraction at an intermediate temperature, i.e. from 140 to 175 °C.

The method may further comprise performing a third aqueous extraction by contacting the spent coffee beans with a hard water at a temperature in excess of 205 °C to obtain a third coffee extract and exhausted coffee beans. Preferably the treatment temperature is from 205 °C to 230 °C, preferably 210 °C to 220 °C.

The method further comprises combining the first and second coffee extracts to form a combined extract. This combined extract may also include the third coffee extract where one has been obtained, as well as any intervening coffee extracts as discussed above. The method further comprises concentrating the combined extract to form the coffee product, such as by evaporation.

If an aroma fraction has been obtained then this is normally added after concentration to avoid loss of volatiles.

The coffee product may then be dried to obtain an instant coffee powder. Preferably the step of drying is a step of spray-drying or a step of freeze-drying. These steps produce a conventional soluble coffee product. Any steps normally used in the production of such products may be used herein, including the addition of gases for foaming and reducing product density, and the supplementation with roast and ground coffee particles or other beverage ingredients such as creamer or sugar. Preferably the coffee product is an instant coffee powder, preferably a spray-dried or a freeze-dried coffee powder.

The first, lower temperature extraction uses soft water. While definitions of water hardness differ between countries, preferably soft water is water that contains divalent metal ions in an amount of less than 0.5 mmol/L, preferably less than 0.2 mmol/L. Preferably the soft water contains less than 50 mg/L of total calcium and magnesium carbonates, preferably less than 20 mg/L.

The second extraction step and, where performed, the third extraction step, which are performed at higher temperatures uses hard water. While definitions of water hardness differ between countries, preferably the hard water contains divalent metal ions in an amount of more than 0.5 mmol/L, preferably more than 0.8 mmol/L and most preferably more than 1.21 mmol/L. Preferably the hard water contains more than 50 mg/L of total calcium and magnesium carbonates, preferably more than 80 mg/L and most preferably more than 120 mg/L.

Preferably the method comprises providing a source of hard water for use in the second extraction step (and optionally third extraction step) and softening a second portion of the hard water to form soft water for use in the first extraction step. Alternatively the method comprises providing a source of soft water for use in the first extraction step and increasing the hardness of a second portion of the soft water to form hard water for use in the second extraction step (and optionally third extraction step). The second alternative is less preferred as it involves adding chemicals to the water during the coffee production which would need to meet stringent controls.

Although preferred embodiments of the invention have been described herein in detail, it will be understood by those skilled in the art that variations may be made thereto without departing from the scope of the invention or of the appended claims.

1. A method of obtaining an instant coffee product, the method comprising:
performing a first aqueous extraction by contacting roast and ground coffee beans with a soft water at a temperature of up to 140 °C to obtain a first coffee extract and partially spent coffee beans; and
performing a second aqueous extraction by contacting the partially spent coffee beans with a hard water at a temperature of from 175 to 205 °C to obtain a second coffee extract and spent coffee beans;
combining the first and second coffee extracts to form a combined extract; and
concentrating and optionally drying the combined extract to form the coffee product,
wherein the soft water contains divalent metal ions in an amount of less than 0.2 mmol/L and wherein the hard water contains divalent metal ions in an amount of more than 0.8 mmol/L.

2. The method according to claim 1, wherein the coffee product is an instant coffee powder.

3. The method according to claim 1, wherein the coffee product is a concentrated liquid coffee product.

4. The method according to claim 1, wherein the method further comprises performing a third aqueous extraction by contacting the spent coffee beans with a hard water, wherein the hard water contains divalent metal ions in an amount of more than 0.8 mmol/L, at a temperature in excess of 205 °C to obtain a third coffee extract and exhausted coffee beans; and
wherein the third coffee extract is combined with the first and second coffee extracts in the combined extract.

5-8. (canceled)

9. The method according to claim 1, the method comprising:
providing a source of hard water for use in the second extraction step;
softening a second portion of the hard water to form soft water for use in the first extraction step.

10. The method according to claim 1, wherein the hard water contains divalent metal ions in an amount of more than 1.21 mmol/L.

11. The method according to claim 1, wherein the soft water contains less than 20 mg/L of total calcium and magnesium carbonates.

12. The method according to claim 1, wherein the hard water contains more than 80 mg/L of total calcium and magnesium carbonates.

13. The method according to claim 1, wherein the hard water contains more than 120 mg/L of total calcium and magnesium carbonates.

14. The method according to claim 2, wherein the coffee product is a spray-dried or a freeze-dried coffee powder.

15. The method according to claim 1, wherein the first aqueous extraction with the soft water is at a temperature of 120 to 140 °C.

16. The method according to claim 1, wherein before performing the first aqueous extraction the coffee beans are subjected to a steam stripping or aroma recovery step to obtain an aroma fraction.

17. The method according to claim 16, wherein the aroma fraction is added to the combined extract after the concentration step.

18. The method according to claim 1, wherein the second aqueous extraction with the hard water is at a temperature of 180 to 200 °C.

19. The method according to claim 4, wherein the third aqueous extraction with the hard water is at a temperature of 210 to 220 °C.
